(19) United States
(12) Patent Application Publication
(10) Pub. No.: US 2009/0021818 A1
(43) Pub. Date: Jan. 22, 2009

(54) MEDICAL SCANNING ASSEMBLY WITH VARIABLE IMAGE CAPTURE AND DISPLAY

(75) Inventors: Michael P. Weir, Blanchester, OH (US); Robert J. Dunki-Jacobs, Mason, OH (US); Jere J. Brophy, Loveland, OH (US); Michael S. Cropper, Edgewood, KY (US); Thomas W. Huitema, Cincinnati, OH (US); Ronald J. Kolata, Raleigh, NC (US); Gary L. Long, Cincinnati, OH (US); Paul G. Ritchie, Loveland, OH (US); Jane A. Sheetz, Cincinnati, OH (US); Robert M. Trusty, Cincinnati, OH (US); Bradley E. White, Cincinnati, OH (US); David C. Youmans, Loveland, OH (US)

Correspondence Address: THOMPSON HINE L.L.P.;Intellectual Property Group, P.O. BOX 8801, DAYTON, OH, 45401-8801, US

(73) Assignee: ETHICON ENDO-SURGERY, INC.

(21) Appl. No.: 11/780,950

(22) Filed: Jul. 20, 2007

(51) Int. Cl. G02B 26/08; H04N 3/08

(52) U.S. Cl. 359/224; 348/205; 348/E03.009

(57) ABSTRACT

A scanned beam imaging system including a housing suitable for insertion into a body and a radiation source configured to direct a beam of radiation into or through the housing and onto an area within the body. The scanned beam imaging system further includes an adjustable element inside the housing and positioned to reflect the beam of radiation or to receive the beam of radiation therethrough, wherein the adjustable element is physically adjustable to vary a property of the beam of radiation that is reflected thereby or received therethrough. The scanned beam imaging system further includes a collector configured to receive radiation returned from the area within the body.

The present application is directly to medical imaging devices, and more particularly, to medical imaging devices utilizing a scanned beam imager.

### BACKGROUND

Imaging devices may be used to provide visualization of a site within a patient. One such device is described in U.S. Patent Publication Number 2005/0020926; corresponding to U.S. application Ser. No. 10/873,540, filed on Jun. 21, 2004, the entire contents of which are hereby incorporated by reference as if fully set forth herein. In such systems a scanned beam imaging system may utilize a radiation source or sources. The radiation is scanned onto or across an area of a patient. The radiation is reflected, scattered, refracted or otherwise perturbed by the illuminated area. The perturbed radiation is then gathered/sensed and converted into electrical signals that are processed to generate a viewable image. However, existing methods and devices do not provide for certain display features which can aid in visualization and/or diagnosis.

### SUMMARY

In one embodiment the present invention is a method and device for generating an image with a variable display. More particularly, in one embodiment the invention is a scanned beam imaging system including a housing suitable for insertion into a body and a radiation source configured to direct a beam of radiation into or through the housing and onto an area within the body. The scanned beam imaging system further includes an adjustable element inside the housing and positioned to reflect the beam of radiation or to receive the beam of radiation therethrough, wherein the adjustable element is physically adjustable to vary a property of the beam of radiation that is reflected thereby or received therethrough. The scanned beam imaging system further includes a collector configured to receive radiation returned from the area within the body.

In another embodiment the invention is a scanned beam imaging system including an elongated housing suitable for insertion into a body and having an area, in end view of less than about 19 mm². The scanned beam imaging system further includes a radiation source configured to direct a beam of radiation into or through the housing, and a scanning reflector positioned in the housing and configured to direct the beam of radiation onto an area within the body. The scanned beam imaging system further includes a collector positioned in the housing and configured to receive radiation returned from the area within the body, and a display device operatively coupled to the collector. The display device is configured to display a representation of radiation received by the collector to thereby display a representation of the area with the body. The display device is configured, upon receiving an input from an operator, to display a zoomed image of part of the representation, wherein the image is electronically zoomed by post radiation-acquisition processing.

In another embodiment the invention is a scanned beam imaging system including a housing suitable for insertion into a body, a radiation source configured to direct a beam of radiation into or through the housing, and a scanning reflector configured to direct the beam of radiation onto an area within the body. The scanned beam imaging system further includes a collector configured to receive radiation returned from the area within the body, and a controller operatively coupled to the reflector to control the oscillations of the reflector. The controller is configured, upon receiving an input from an operator, to vary the amplitude and center of oscillations to provide a zoom and pan feature. The controller is configured to vary the of oscillations such that a predetermined point remains generally at the center of the area scanned by the directed beam of radiation.

In another embodiment the invention is a scanned beam imaging system including a housing suitable for insertion into a body, a radiation source configured to direct a beam of radiation into or through the housing, and at least two scanning reflectors configured to direct the beam of radiation onto an area within the body, wherein the combined range of oscillation of the reflectors is greater than 180 degrees. The scanned beam imaging system further includes a collector configured to receive radiation returned from the area within the body.

In another embodiment, the invention is a scanned beam imaging system including a housing suitable for insertion into a body, a radiation source configured to direct a beam of radiation into or through the housing, and a scanning reflector configured to direct the beam of radiation onto an area within the body. The scanned beam imaging system further includes a collector configured to receive radiation returned from the area within the body, wherein at least one of the collector or the reflector is movable relative to the other.

In another embodiment, the invention is a scanned beam imaging system including a housing suitable for insertion into a body, a radiation source configured to direct a beam of radiation into or through the housing, and a scanning reflector configured to direct the beam of radiation onto an area within the body. The scanned beam imaging system further includes collector including an aperture for receiving radiation returned from the area within the body, wherein the aperture is conformable into various forms.

In another embodiment, the invention is a scanning system including a scanned beam imaging system having a housing suitable for insertion into a body, a radiation source configured to direct a beam of radiation into or through the housing, and a scanning reflector configured to direct the beam of radiation onto an area within the body. The scanned beam imaging beam system further includes a collector configured to receive radiation returned from the area within the body, wherein the scanned beam imaging system is configured to capture image data of at least two differing areas within the area of the body with different magnification with respect to the differing areas. The scanning system further includes a display device operatively coupled to the collector. The display device is divided into six display zones that are simultaneously viewable, wherein at least some of the display zones are configured to display representations of the at least two differing areas.

The details of one or more embodiments of the invention are set forth in the accompanying drawings and the description below. Other features, objects, and advantages of the invention will be apparent from the description and the drawings, and from the claims.

### BRIEF DESCRIPTION OF THE DRAWINGS

FIG. 1 is a side cross section and schematic representation of one embodiment of the scanning assembly of the present invention;

FIG. 2 is a front view taken along line 2-2 of FIG. 1;

FIG. 3 is a representation of a path of scanned radiation output by the scanning assembly of FIG. 1;

FIG. 4 is a perspective view of the scanning assembly of FIG. 1;

FIG. 5 is a schematic representation of radiation reflected by the reflector at two different positions;

FIG. 6 is a detail side cross sectional view of the one embodiment of the beam shaping optics of the scanning unit of FIG. 1, shown in a first configuration;

FIG. 7 is a side cross sectional view of the beam shaping optics of FIG. 6, shown in a different configuration;

FIG. 8 is a rear view of a reflector assembly including a reflector adjusting system;

FIG. 9 is a front perspective view of the reflector of FIG. 8;

FIG. 10 is a front perspective view of the reflector of FIG. 9, conformed into a concave shape;

FIG. 11 is a front perspective view of an optical element and a reflecting surface;

FIG. 12 is a schematic representation of a reflector at two different positions;

FIG. 13 is a schematic representation of a reflector oscillating at a first amplitude;

FIG. 14 is a schematic representation of a reflector oscillating at a second amplitude;

FIG. 15 is a schematic representation of a reflector oscillating in an off-center manner;

FIG. 16 is a schematic representation of a reflector oscillating at a first amplitude and direction, with an instrument within the scanned region;

FIG. 17 is a schematic representation of the reflector FIG. 16 oscillating at a second amplitude and direction after a tracking feature has been activated;

FIG. 18 is a schematic representation of a reflector, a collector and an associated display;

FIG. 19 is a schematic representation of the reflector, collector and display of FIG. 18, illustrating a zoomed image;

FIG. 20 is a side cross section and schematic representation of a scanning assembly utilizing two reflectors;

FIG. 21 is a side cross section and schematic representation of another scanning assembly utilizing two reflectors;

FIG. 22 is a schematic representation of a scanning unit and separate collector;

FIG. 23 is a front perspective view of a scanning unit coupled to a surgical instrument;

FIG. 24 is a front perspective view of a scanning unit slidably coupled to a surgical instrument;

FIG. 25 is a side cross section of a conformable scanning unit positioned within a passage;

FIG. 26 is a side cross section of the conformable scanning unit of FIG. 25 positioned in a differently-shaped passage;

FIG. 27 is a schematic representation of a screen divided into screen segments; and

FIG. 28 is a side cross section of an optical element usable with a scanning unit.

### DETAILED DESCRIPTION

Before explaining the several expressions of embodiments of the present invention in detail, it should be noted that each is not limited in its application or use to the details of construction and arrangement of parts illustrated in the accompanying drawings and description. The illustrative expressions of embodiments of the invention may be implemented or incorporated in other embodiments, variations and modifications, and may be practiced or carried out in various ways. Furthermore, unless otherwise indicated, the terms and expressions employed herein have been chosen for the purpose of describing the illustrative embodiments of the present invention for the convenience of the reader and are not for the purpose of limiting the invention.

It is further understood that any one or more of the following-described expressions of embodiments, examples, etc. can be combined with any one or more of the other following-described expressions of embodiments, examples, etc.

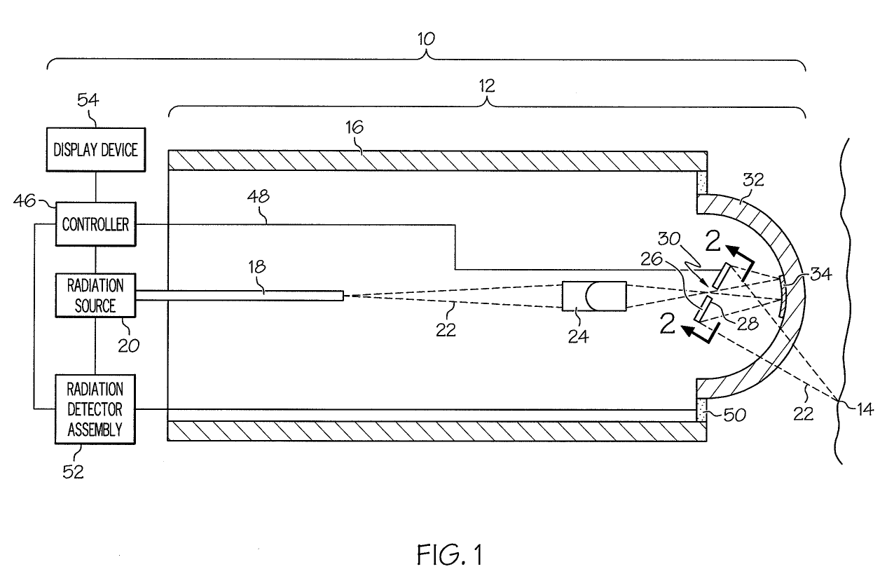

As shown in FIG. 1, a scanning assembly, generally designated 10, may include a scanning unit 12 configured direct radiation onto an area 14 of the body of a human or animal patient. The scanning unit 12 (or other components or subcomponents) can then detect the radiation that is reflected, scattered, refracted or otherwise perturbed or affected (hereinafter referred to as radiation that is “returned from” the illuminated area 14) by the area 14 receiving radiation. The detected radiation can then be analyzed and processed to generate an image of the illuminated area 14.

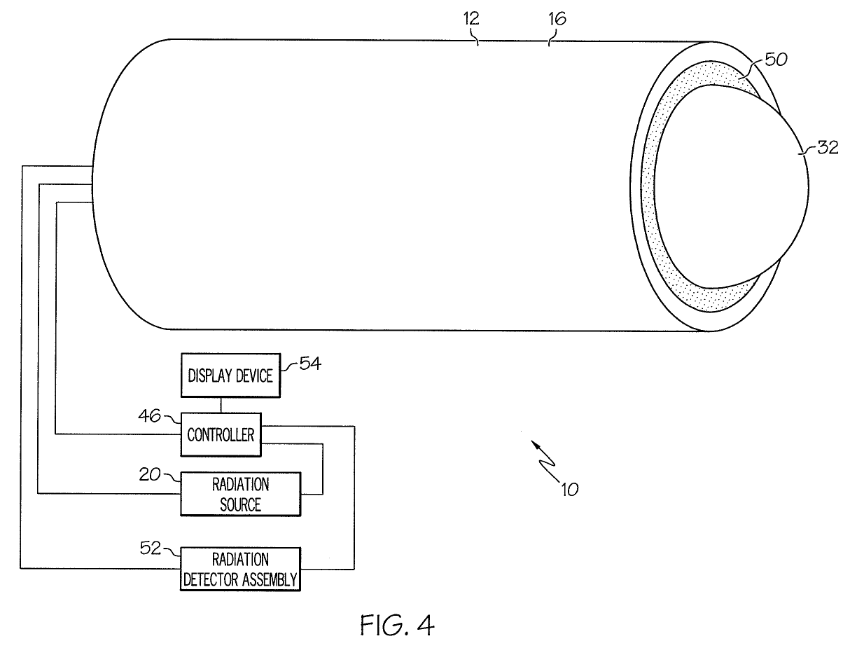

The scanning unit 12 includes a housing 16 which receives a source fiber 18 therein. In the illustrated embodiment the housing 16 is generally cylindrical (see FIG. 4) and sized to be used gripped and manually manipulated, although the housing 16 can take any of a variety of forms, shapes and sizes. The source fiber 18 is operatively coupled to a radiation source 20 to transmit radiation from the radiation source 20 to a position inside of the housing 16 or adjacent to a reflector 26. The radiation source 20 can take any of a variety of forms, including light emitting diodes (LEDs), lasers, thermal sources, arc sources, fluorescent sources, gas discharge sources, other sources, or combinations of these sources. The radiation provided by the radiation source 20 can include energy in the visible light spectrum, such as red, green, or blue radiation, or various combinations thereof, although the radiation need not necessarily be within the visible spectrum. The source fiber 18 may take the form of one or more optical fibers, or various other energy transmission means sufficient to transmit radiation from the radiation source 20.

The end of the source fiber 18 may be shaped or polished to create a beam 22 of known divergence. After exiting the source fiber 18 the beam 22 passes through, and is shaped by a lens (not shown) and/or by (optional) beam shaping optics 24 to create a desired beam shape. Various features and operation of the optics 24 will be described in greater detail below.

The scanning unit 12 includes the mirror or reflector 26 at or adjacent to its distal end. The reflector 26 may take the form of a micromirror or other reflective surface. The reflector 26 thus may take the form of or include a microelectrical mechanical system (“MEMS”) manufactured using standard MEMS techniques. The reflector 26 may include a semiconductor substrate, such as silicon, with a reflective outer surface, such as gold or other suitable material, forming its outer reflective surface 28. However the reflector 26 may take various other forms, such as a multilayer dielectric coating.

In the illustrated embodiment the reflector 26 includes a central aperture 30 that is positioned to allow the beam 22 to pass therethrough. However, the reflector 26 and scanning unit 12 can take any of a variety of shapes and configurations besides that shown herein. For example, rather than including a central aperture 30 that allows the beam 22 to pass therethrough, the beam 22 may be laterally offset from the reflector 26, and guided to the reflector 26 by another mirror/reflector.

After passing through the aperture 30 of the reflector 26 the beam 22 approaches an optical element 32 that is positioned at a distal end of the scanning unit 12. The optical element 32 can be generally hemispherical and is typically referred to as a dome. However, the shape, curvature, contour, and surface treatment of the optical element 32 may vary depending on the desired application/use of the scanning unit 12 and the desired optical properties of the optical element 32. The optical element 32 may form a hermetic seal with the housing 16 to protect the internal elements of the scanning unit 12 from the surrounding environment.

The optical element 32 may include a reflecting surface 34 on its inner surface. The reflecting surface 34 may be directly deposited on the inner surface of the optical element 32, or can take the form of a separate and discrete element coupled to the optical element 32. In either case, after the beam 22 passes through the aperture 30 of the reflector 26, the beam 22 impinges upon the reflecting surface 34 which reflects the beam 22 and re-directs the beam 22 toward the reflector 26. The inner surface of the optical element 32 and/or the reflecting surface 34 may also shape the beam 22 as desired due to the shape or curvature of the optical element 32 reflecting surface 34. In addition, rather than utilizing a reflecting surface 34, the optical element 32 may be made of a semi-reflecting material such that at least part of the beam 22 is reflected back as shown in FIG. 1. Furthermore, if the beam 22 is laterally offset from the center of the scanning unit 12 in the arrangement briefly described above, the reflecting surface 34 on the optical element 32 may be omitted.

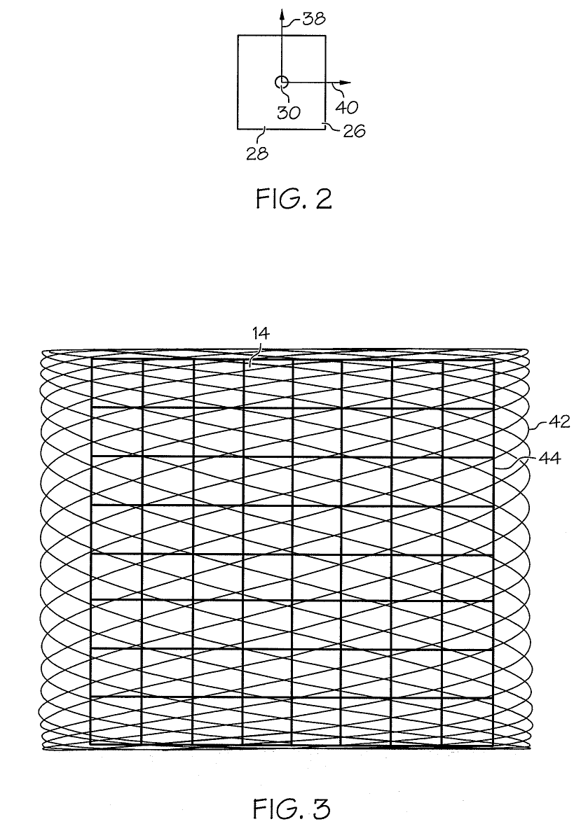

The reflector 26 may be independently oscillatable/movable about two orthogonal axes, such as axes 38, 40 shown in FIGS. 2 and 8. Thus the reflector 26 may double gimbaled or otherwise pivotable about the two axes 38, 40 to direct the beam 22 as desired. The range of motion of the reflector 26 can be selected as desired, but in one embodiment the reflector 26 is pivotable about the axis 38 at least about 120 degrees, or in another case at least about 60 degrees, and the reflector 26 is pivotable about the axis 40 at least about 60 degrees, or in another case at least about 40 degrees (with all angles being full angle values representing the full range of motion of the reflector 26). The reflector 26 may guide the beam 22 about a field of view, which can be considered the angular extent about which the beam 22 extends relative to the axes 38, 40.

In one embodiment the reflector 26 is moved such that the reflector 26 has a significantly higher frequency about one axis than about the other axis. For example, in one embodiment the reflector 26 is moved such that it has a frequency about the axis 40 that is at least about fifteen times greater, up to about 600 times or even greater, than the frequency of oscillation about the axis 38. In one embodiment the reflector 26 may have a frequency of about 19 kHz about the axis 40, and about 60 Hz about the axis 38.

The reflector 26 may be moved about each axis 38, 40 in a reciprocating motion having a velocity profile that is generally sinusoidal to provide a bi-sinusoidal scan pattern. However, the velocity profile need not necessarily be at or close to sinusoidal. Furthermore, the reflector 26 may be oscillated at or close to resonant frequency about each axis 38, 40 (i.e. in a dual resonant manner). However, the frequency of oscillations can be at nearly any desired value to allow the reflected beam 22 to scan across the illuminated area 14 in the desired manner (such as in a progressive scan pattern). For example, FIG. 3 illustrates a classical Lissajous pattern 42 (imposed upon a grid 44) which may be scanned upon an area 14 during operation of the scanning unit 12. However, the scan pattern need not necessarily be implemented by a progressive scan pattern. Instead, the scan pattern can take any of a variety of other shapes or forms, including a spiral pattern scanned by a flexible or movable optical fiber, or nutating mirror assembly, or the like.

The movement/oscillation of the reflector 26 may be controlled by a controller 46 (FIG. 1) that is operatively coupled to the reflector 26 by a connection 48. The reflector 26 may be movable/oscillatable through the application of various forces, such electrical/electrostatic forces, which can be applied by electrostatic plates, comb drives, or the like (i.e. see comb drives 47 in FIG. 8). However, various other forces may be utilized to drive the movement/oscillation of the reflector 26, such as magnetic, piezoelectric, or combinations of these drivers. In addition, besides conveying drive signals to the reflector 26, the connection 48 can convey informational signals (i.e., position, feedback, temperature, etc.) from the reflector 26 to the controller 46. Alternately, the position of the reflector 26 can be determined or tracked optically.

After the beam 22 is directed by the reflector 26, the beam 22 passes through the optical element 32. The optical element 32 can be shaped and/or made of certain materials to further direct the exiting beam 22 as desired. Once the beam 22 pass through the optical element 32 the beam 22 can impinge upon the area 14.

The scanning unit 10 includes a collector 50, which collects/senses radiation emitted by the scanning unit 12 that is returned from the illuminated area 14. In the embodiment of FIG. 1 the collector 50 is configured coaxially within the housing 16 (see also FIG. 4). However, as will be described below, the collector 50 may take a variety of shapes and forms, and also need not necessarily be physically coupled to the housing 16. Since the image of the illuminated area 14 is constructed from the point of view of the “illuminator” (i.e. the reflector 26), the position at which the radiation is collected does not effect the geometry of the image. For example, as the collector 50 is moved, the shapes of the images or structures in the illuminated area 14 may become more or less visible, or even change from visible to not visible, but the geometry of the shapes, and their spatial relationship, remains unchanged. However, movement of the collector 50 may effect the quality of the image. Thus in any case the collector 50 should be located sufficient close to the illuminated area 14 to effectively detect perturbed radiation.

The collector 50 may take any of a variety of forms, and in one embodiment includes a plurality of small diameter, multimode collecting fibers. The ends of the fibers may be polished and arranged in a generally planar manner (or otherwise) to define an aperture. When the reflector 26/scanning unit 12 directs radiation 22 at the area 14, returned radiation impinges on the aperture, and the collecting fibers then conduct the received radiation to a radiation detector assembly 52. The radiation detector assembly 52/controller 46 may be operatively coupled to a display device 54 (such as a display screen, television screen, monitor, etc.) that can display a visual representation of the illuminated area 14 based upon data provided by the collector 50.

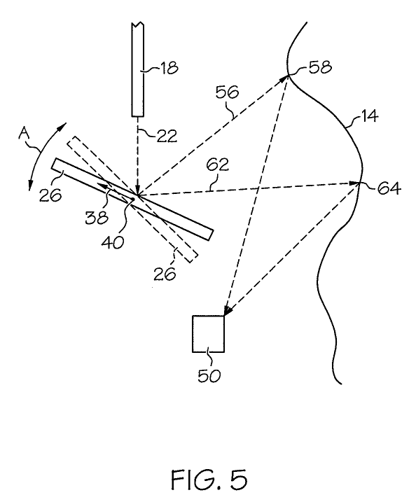

FIG. 5 schematically illustrates the operation of the reflector 26 in conjunction with the collector 50. The reflector 26 receives a beam of radiation 22 from the source fiber 18 and directs the beam 22 onto a surface or illuminated area 14. At a first point in time, the beam 22 deflected by the reflector 26 is in a position shown as 56, and impinges upon the surface to illuminate point 58. As the reflector 26 moves or oscillates about axis 40 (indicated by arrow A) at a later point in time the beam is in the position shown as 62 where the beam illuminates point 64. The directed radiation is reflected, absorbed, scattered, refracted or otherwise affected by the filed of view 14, at least some of which is detected by the collector 50. The perturbed radiation may leave the area 14 in many directions and thus the collector 50 may only capture that fraction of reflected radiation which reaches its aperture.

Radiation that is intercepted by the collector 50 is passed to the radiation detector assembly 52. The radiation detector assembly 52 may take the form of or include a bolometer, photodiode or avalanche photodiode that can output a series of electrical signals corresponding the power, amplitude, or other characteristic of each wavelength of radiation detected. The signals can be used/processed by the controller 46 (or a separate controller) to generate an image of the illuminated area 14 which can be displayed on a display device 54, or printed, stored, or further processed. The image can be generated by taking into consideration, for example, the position, angle, intensity and wavelength of beam 22 directed by the reflector 26, and the amount and/or wavelength of radiation sensed by the collector 50.

The housing 12 may constitute or include an elongate shaft (which can be either rigid or flexible) that is insertable into the body of a patient. The radiation source 20, controller 46, radiation detector assembly 52, and display device are 54 typically not insertable into the patient, but are instead typically components positioned outside the body and accessible for use and viewing.

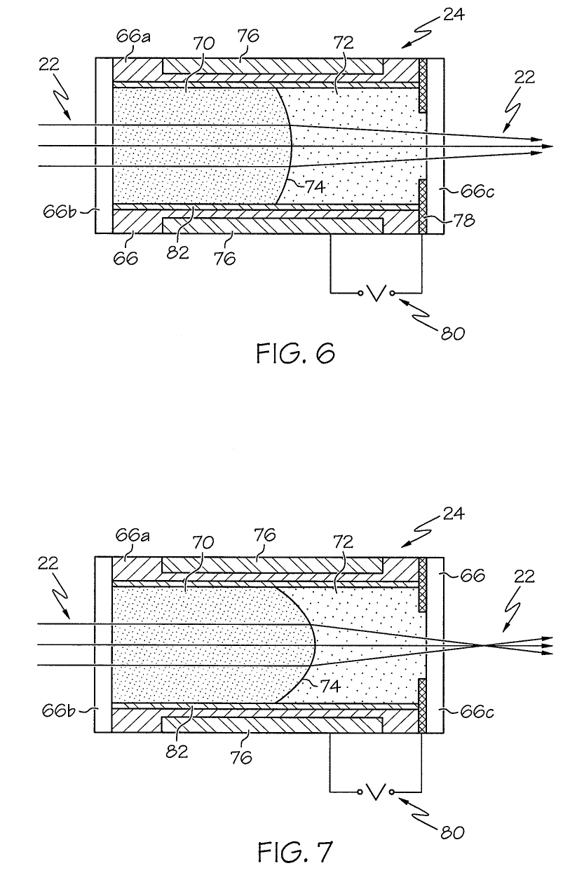

The beam shaping optics 24, described above and schematically shown in FIG. 1, may be utilized to control the shape/divergence of the beam 22 passing therethrough. FIGS. 6 and 7 illustrate, in more detail, an embodiment wherein the scanning unit 12 utilizes an adjustable or deformable lens or lens system, generally designated 24, which can take the form of a fluid lens or tunable microlens. The lens system 24 includes an encapsulator 66, such as a cylinder having a side wall 66a, and a pair of ends 66b, 66c. However, the encapsulator 66 can take any of a variety of shapes or forms beside cylindrical. The ends 66b, 66c of the cylinder 66, and optionally the side wall 66a, are generally transparent or translucent. The cylinder 66 is generally axially aligned with the beam 22.

The cylinder 66 receives and contains an electrically insulating material 70 and an electrically conductive material 72 therein. The electrically insulating material 70 and electrically conductive materials 72 can be fluids, gases, deformable solids, or combinations thereof. The electrically insulating material 70 and electrically conductive material 72 define an interface/meniscus 74 therebetween, and the materials 70, 72 may be immiscible materials to maintain the interface 74. For example, in one embodiment the electrically insulating material 70 is a non-conducting oil (such as silicone oil or an alkane), and the electrically conductive material 72 is an aqueous solution (such as water containing a salt solution). The electrically insulating material 70 and electrically conductive material 72 may have differing refractive indices. In addition, the materials 70, 72 may have about the same density such that gravity does not effect the shape of the meniscus 74.

The lens system 24 may include a generally cylindrical electrode 76 extending about the materials 70, 72. The end wall 66a may be electrically insulating to electrically isolate the electrode 76 from the materials 70, 72. A second, annular electrode 78 is positioned adjacent the end wall 66c to act upon the electrically conductive material 72, and a voltage source 80 is electrically coupled to the electrodes 76, 78. The inner surface of the cylinder 66 is coated with a hydrophobic coating 82 that reduces the contact angle of the meniscus 74 with the side wall 66a of the cylinder 66. In addition, if desired one or both end walls 66b, 66c may be coated with the hydrophobic coating 82 on their inner surfaces.

When no voltage is applied, the materials 70, 72 may arrange themselves such that the interface 74 takes the shape as shown in FIG. 6 wherein the electrically conductive, aqueous solution 70 has a lower wettability compared to the electrically insulating, oil solution 72 due to the hydrophobic coating 82. In this arrangement, when the beam 22 passes through the lens system 24, the beam 22 is optically altered in a certain manner (i.e. in the illustrated embodiment, focusing the beam 22 such that the lens system 24 acts as a convergent lens with a certain focal length).

When a voltage is applied to the electrodes 76, 78 by the voltage source 80, the hydrophobic qualities of the hydrophobic coating 82, and/or the attractive/repulsive nature of the material(s) 70, 72, is modified. More particularly, when a voltage is applied to the electrode 78, opposite charges collect in the electrically conductive material 72 near the meniscus 74. The resulting electrostatic forces lower the interfacial tension, thereby changing the shape of the meniscus 74 and the focal length of the lens system 24. Thus, as shown in FIG. 7, an applied electrical voltage may decrease the focal length of the lens system 24 as compared to FIG. 6.

Moreover, the lens system 24 can be arranged in various other manners than that identically shown herein. For example rather than utilizing a hydrophobic coating 82, a coating which repels oil-based (or other) fluids/materials may be utilized. Moreover the lens system 24 can be arranged such that the lens system 24 is initially a lens that causes divergence of a beam passed therethrough; or that an increase in voltage causes the lens to become increasing divergent (rather than convergent). Similar lens systems are described in U.S. Pat. No. 7,126,903 to Feenstra et al., issued on Oct. 24, 2006, and U.S. Pat. No. 6,369,954 to Berge et al. issued on Apr. 9, 2002. The entire contents of both of these patents are incorporated herein.

The lens system 24 (as well as other optical tools discussed below) allows the beam 22 to be focused as desired to provide desired qualities to the end image. For example, when the scanning unit 12 is positioned close to the illuminated area 14, the beam 22 is desired to be focused (i.e. converge) at a relatively short distance in front of the scanning unit 12. The ability to focus the beam 22 to a smaller spot on the area 14 also allows items positioned close to the scanning unit 12 to be viewed more clearly. With sufficient zooming and proper circumstances (i.e. short range and high resolution), microscopy capabilities may be provided by the scanning unit 12. With microscopy capabilities further inspection and diagnoses may be able to made in vivo during a scanning/medical procedure, which may avoid having to conduct in vitro analysis.

In contrast, when the scanning unit 12 is positioned relatively far from the area 14, the beam 22 is desired to be focused at a relatively long distance from the front of the scanning unit 12. In addition, the lens system 24 can be used in combination with one or more fixed, or variable, lens systems. For example the lens system 24 can be used as an objective lens to provide focus and/or zoom.

The lens system 24 can be relatively small; for example, in one case has a diameter of less than about 10 mm, and in another case, less than about 5 mm. Moreover, since the lens system 24 is electronically adjustable, instead of mechanically adjustable, reliability, robustness and response time of the lens system 24 may be improved compared to mechanically adjustable systems. Accordingly, the lens 24 system allows for rapid and reversible modification in the focal length of the lens system 24 due to application/variation of a voltage. For example, in one embodiment the lens system 24 may be able to adjust between its full focal range (from about 5 cm to infinity) in less than 10 ms.

In addition, the configuration of the lens system 24 and beam 22 allows the lens system 24 to operate upon primarily paraxial rays (i.e. the beam 22), as opposed to rays arriving from various angles and directions (which must be focused in focal plane array systems). The lens system 24 may be better suited for use with paraxial rays, and therefore the use of the lens system 24 in the scanning unit 12 (as a beam focuser; as opposed to use in a focal plane array to focus received radiation) may provide good results. The lens system 24 may also be particularly suited for use with a beam of a known and predictable position, such as beam 22. In this case the lens system 24 can be made relatively small, which lowers manufacturing costs and helps to ensure the scanning unit 12 as a whole is relatively small.

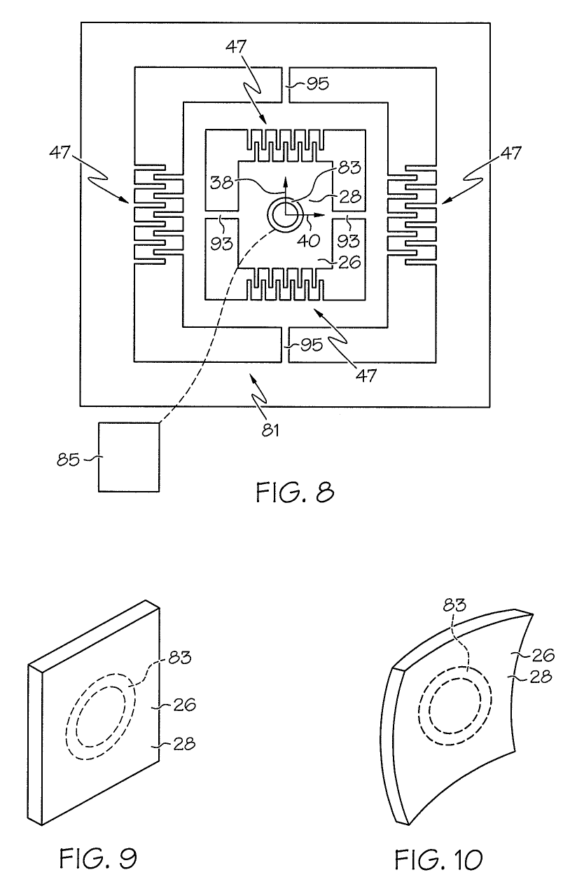

The beam 22 can also be focused (i.e. its waist adjusted) by other means. For example, as shown in FIGS. 8 and 9, the reflector 26 may be nominally flat in its normal condition. A reflector adjusting system, generally designated 81, may be operated to adjust the reflector 26 out of its nominal flat condition, such as into concave or convex shapes. In the illustrated embodiment the reflector adjusting system 81 includes an adjusting element 83 positioned on the back side of the reflector 26. The adjusting element 83 may be mechanically coupled to the reflector 26, but generally thermally (and in some cases electrically) isolated from the reflector 26. The adjusting element 83 may be made of a material having significantly different coefficient of thermal expansion (i.e. at least about 10%) as compared to the material of the reflector 26.

A thermal source, generally designated 85, is operatively coupled to the adjusting element 83. In the illustrated embodiment, the adjusting element 83 may be made of or substantially include an electrically conductive material, and the thermal source 85 may be a current source. In this case, when a current is passed through the adjusting element 83 by the current source 85, the adjusting element 83 rises in temperature compared to the reflector 26 due to resistive heating. The differing coefficient of thermal expansion, and/or difference in temperature, causes the adjusting element 83 to expand at a different rate than the reflector 26, thereby inducing stresses and causing the reflector 26 to be elastically conformed into a convex or concave (FIG. 10) shape.

The electrical current can be adjusted as desired to produce the desired amount of adjustment in the reflector 26. It is believed that deforming the reflector 26 from a flat shape to a shape with slight curvature could significantly adjust the waist of the external beam. For example, it is projected that adding about 1 micrometer of sag at the center of a one mm diameter reflector 26 could adjust the external focus by about 56 mm.

In the illustrated embodiment the adjusting element 83 is arranged in the shape of a circle. However, the adjusting element 83 can take any of a variety of shapes, including various geometric shapes (such as squares, triangles, etc.) a generally cross or “X” shape, as well as various lines, curves, etc. Moreover, rather than taking the shape of a line or a series of lines, the adjusting element 83 may be made of an array of adjusting elements positioned on the reflector 26 as desired.

Various other methods besides resistive heating may be utilized to raise the temperature of the adjusting element 83. For example, rather than passing a current through the adjusting element 83, a laser or other radiation may be directed at the adjusting element 83. In this case the adjusting element 83 may be coated with an absorbing layer to promote heating of the adjusting element 83. In addition, piezoelectric, ferroelectric, electroactive polymers, or the like may be utilized as the adjusting element 83 or as part of the adjusting element 83. In addition, rather than heating the adjusting element 83, if desired the reflector 26 may be heated to cause the temperature differential between the reflector 26 and the adjusting element 83.

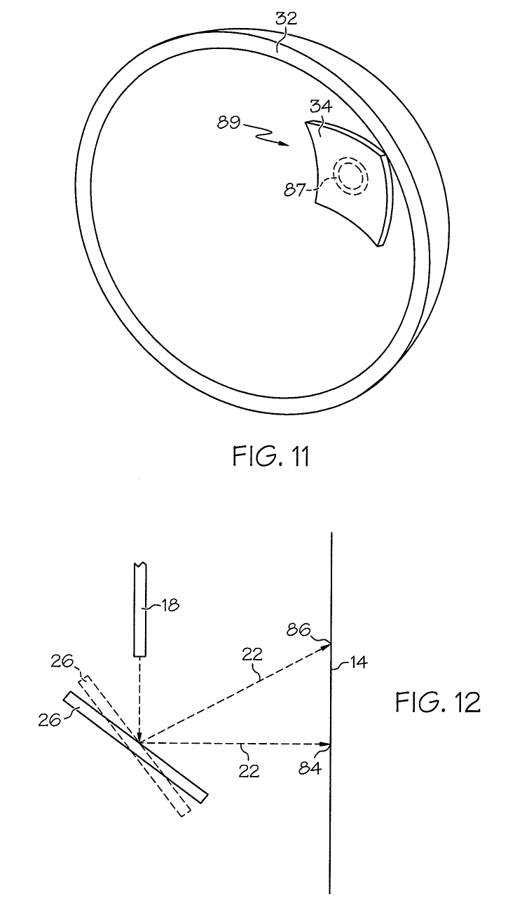

As shown in FIG. 11, the reflecting surface 34 may have an adjusting element 87 coupled thereto to provide a reflective surface adjusting system 89 which operates in an analogous manner to the reflector adjusting system 81. The adjusting element 87 may be operable to adjust the concavity of the reflecting surface 34 as desired. It is believed that deforming the reflecting surface 34 could significantly adjust the waist of the external beam. For example, it is projected that adding about 10 micrometer of curvature to the reflecting surface 34 could adjust the external focus by about 3 mm.

As shown in FIG. 12, when the illuminated area 14 is a plane, the distance the beam 22 travels when aimed straight ahead (i.e. to point 84) is less than the distance the beam 22 travels when the beam 22 travels at an angle (i.e. to point 86). Accordingly the desired focus for the beam 22 when aimed at point 86 can be different from the desired focus for beam 22 when aimed at point 84. Thus in one embodiment the lens system 24, and/or reflector adjusting system 81, and/or reflective surface adjusting system 89 may be configured to provide a dynamic focus that is coordinated with the movement/position of the reflector 26 to accommodate the varying range of the beam 22.

More particularly, as the position of the reflector 26 is known, tracked or predicted, the lens system 24 can adjust the focus of the beam 22 as a function of the position of the reflector 24. For example, the focus of the beam 22 can be adjusted linearly as the beam 22 moves between position 84 and position 86. In this case, the focus of the beam 22 may be adjustable any number of times (i.e. at least two) up to a continuous adjustment, during a single oscillation of the reflector 26. Moreover, various other relationships (besides linear) between the focal length of the lens system 24 and position of the reflector 26 can be utilized. In addition, since the shape of the area 14 can vary, an assumption that the area 14 is planar (as shown in FIG. 12) could be inaccurate. Accordingly, the focus of the beam 22 could also take into account the known or predicted contour of the area 14.

The lens system 24 and/or reflector adjusting system 81 and/or reflective surface adjusting system 89 may also be adjustable to reduce motion artifacts. More particularly, during operation of the scanning unit 12 there may be unintended relative motion between the scanning unit 12 and the illuminated area 14. The relative motion may be due to, for example, movement of the patient, (i.e. respiration, peristalsis, reflexive movement or the like), or due to movement of the operator/user (i.e. hand tremors or the like). When there is sufficiently fast relative movement, the image displayed on the display device 54 may be distorted, such as with an interlace effect.

Distortion of the image may be able to be reduced by slightly defocusing the beam 22. If the beam is slightly defocused by the lens system 24 and/or reflector adjusting system 81 and/or reflective surface adjusting system 89 and made less fine, then the effects of relative motion are correspondingly reduced. The defocusing of the beam 22 may be carefully controlled to ensure that any loss of clarity in the displayed image is not of a sufficient level to be noticeable by an operator, or has only a minimal effect upon the displayed image as sensed by the operator.

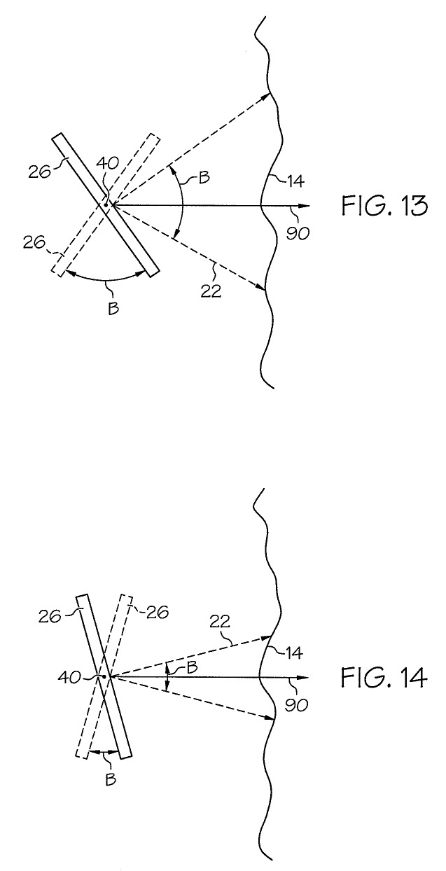

During many procedures an operator, or other personnel or diagnostic tools, may notice an area of interest, such as a lesion, polyp, etc. In addition certain features may be of interest, such as a clamped or stapled tissue, a stent, etc, and the operator may desire a closer look at the area of interest. As shown in FIG. 13, the reflector 26 may, under normal conditions, oscillate about axis 40 by an angle B to define the area 14 which receives directed radiation thereon. Accordingly, when a zoom is desired, the controller may be operated to reduce the angle B (i.e. reduce the amplitude of oscillations), as shown in FIG. 14.

Assuming a constant sampling rate by the radiation detector assembly 52/controller 46, the amount of data relating to the illuminated area 14 collected when the reflector 26 oscillates as shown in FIG. 14 is about equal to the amount of data relating to the illuminated area 14 collected when the reflector 26 oscillates as shown in FIG. 13. Assuming both sets of data are displayed on the full screen of the display device, the data in FIG. 14 corresponds to a smaller area on the same screen size, thereby effectively providing a zoom feature with no loss in resolution. The same principle can be utilized in reverse; that is, the angle B can be increased when it is desired to “zoom-out” to provide a larger illuminated area.

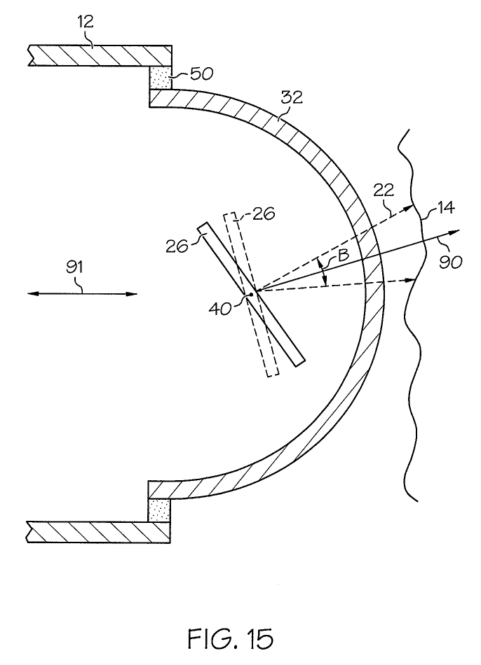

Moreover, if desired the reflector 26 may be able to adjust its center of oscillation such that its center of oscillation is offset from a previous center of oscillation, or is offset from a “default” center of oscillation (about at least one axis), or is offset from an angle when the reflector is in a rest position (i.e. when no external forces are applied to the reflector 26), or is offset from a geometric center of the scanning unit 12/housing 16. For example, as shown in FIG. 15, the center of rotation 90, which bisects angle B, is offset from the center of rotation 90 of the embodiments shown in FIGS. 9 and 10 (which is a horizontal line in those figures). The center of rotation 90 is also offset from (i.e. forms an angle with) the geometric centerline 91 of the scanning unit 12/housing 16. Adjustment of the center of oscillation 90 provides a panning feature such that areas of interest in the area 14 can be centered, and, if desired, zoomed in or out by changing the angle B.

Rather than adjusting or offsetting the angle B, zooming and/or panning can be provided by adjusting the end points of oscillation of the reflector 26 (i.e. the two positions at which the reflector 26 changes position). For example, if a “hard” end point or outer point of oscillation is desired, the controller 40 can implement such control. Moreover, it is noted that for ease of illustration FIGS. 13-15 illustrate an adjustment of oscillation about a single axis 40. During actual zooming and panning operations adjustment of oscillations of the reflector 26 can be implemented about one or both axes 38, 40, or other references.

The reflector 26 can be driven in the off-center, or offset, oscillation shown in FIG. 15 in a variety of manners. More particularly, the reflector 26 may be pivotable about axis 40 about a pair of torsion arms 93 (FIG. 8) that are positioned on opposite sides of the reflector 26 and aligned with the axis 40. The reflector 26 may be pivotable about axis 38 about torsion arms 95. In the absence of outside forces, the reflector 26 may reside in a rest position (i.e. vertically in one embodiment, wherein the center of oscillation 90 is a generally perpendicular horizontal line).

When the reflector 26 is rotated about the axis 40, a torsion force is induced in the torsion arms 93 which seeks to cause the reflector 26 to seek to return to the rest position. Accordingly, in order to drive the reflector 26 in an offset manner, as shown in, for example, FIG. 15, the controller 46 may be able to take into account the forces applied to the reflector 26 by the torsion arms 93, and thereby correspondingly adjust the drive signal such that the reflector 26 is oscillated in the desired manner. Oscillation about the axis 38 and arms 95 can be controlled in a similar manner.

The offset oscillation shown in FIG. 15 can be driven in a generally sinusoidal manner, and/or at a generally resonant frequency, or in other manners. In addition, rather than adjusting the drive signal, the physical properties of the torsion bars 93/95, and/or reflector 26 can be adjusted. For example, the torsion arms 93/95 may be twisted, or pre-stressed, to offset the center of rotation of the reflector 26 in the desired manner. Various other methods for driving the reflector 26 in an off-center manner can also be implemented.

Thus this technique provides a zoom and pan feature without having to adjust a lens in the manner required for zooming in a focal plane array imaging system. Moreover, the physical orientation of the scanning unit 12 relative to the illuminated area 14 can remain unchanged during zooming and panning which allows easier operation since further physical manipulation is not required to change the illuminated area 14.

The zooming and panning feature described herein can be controlled in a variety of manners. For example, an zoom and/or pan inputs for manual operation may be made available to the operator, for example on the housing 16, on a console (which can house the display device 54, and/or controller 46, and/or radiation source 20, and/or radiation detector assembly 52), or elsewhere. Alternately, or in addition, an operator may be able to designate a point or area of interest, such as on a touch screen of the display device 54, or using an input pen/stylus. The controller 46 may then center the indicated point or area, and optionally zoom such that the designated area generally fully fills the screen of the display device 54 to the greatest extent possible.

The lens system 24 and/or reflector adjusting system 81 and/or reflective surface adjusting system 89 described and shown above may be used in conjunction with the panning and zooming features described above and shown in, for example, FIGS. 13-15. More particularly, when the angle of oscillation B is varied, and/or the center of oscillation 90 is varied, the focus of the beam 22 may be correspondingly adjusted. As an example, when comparing FIGS. 13 and 14, when the angle of oscillation B is reduced, and assuming a generally planar area 14, the average range of the beams 22 in FIG. 13 is greater than the average range of the beams 22 in FIG. 14. Accordingly, when switching the angle of oscillation B from that shown in FIG. 13 to that shown in FIG. 14, the lens system 24 and/or reflector adjusting system 81 and/or reflective surface adjusting system 89 may be correspondingly adjusted to shorten the focal length of the beam 22 and provide greater resolution. Of course, the manner in which the lens system 24 and/or reflector adjusting system 81 and/or reflective surface adjusting system 89 is adjusted to accommodate the varying oscillations of the reflector 26 will vary and depend upon a wide variety of factors. However, the lens system 24, reflector adjusting system 81 and reflective surface adjusting system 89 provide a powerful tool to help implement, and provide practical advantages to, the techniques associated panning and zooming by varying the oscillation of the reflector 26.

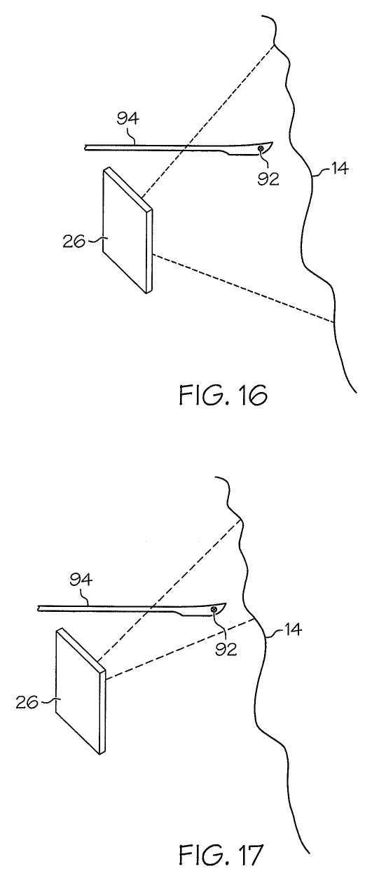

The scanning assembly 10 may be configured to track a point such that the tracked point generally remains at the center of the illuminated area 14. For example, in FIG. 16 the reflector 26 is shown, with the dotted lines representing the outer range oscillation of the reflector 26 thereby defining the area 14. The scanning assembly 10 may be configured to identify a point 92, such as a point positioned on a surgical instrument 94. The oscillation of the reflector 26 may then be adjusted such that oscillation of the reflector 26 is centered about the point 92, as shown in FIG. 17. In this case, as the surgical instrument 94 is moved, the reflector 26 can track the movement of the surgical instrument 94 and manual tracking operations are not necessary. The operator may be able to zoom in or out as desired, and the point 92 may remain in the center of the illuminated area 14 during such zooming.

FIGS. 16 and 17 illustrate the point 92 in the form of a fiducial positioned on the tip of the surgical instrument 94. The fiducial 92 may be, for example, of a shape and/or design and/or color that is easily optically recognized (such as by optical recognition software in the controller 46 and/or radiation detector assembly 52) and configured to be distinct in shape, color, texture or otherwise from surrounding tissue. The fiducial 92 may be, for example, a sticker securely adhered to the surgical instrument 94, or may be integrally formed or molded into the surgical instrument 94.

If desired, the surgical instrument 94 may not necessarily include a fiducial. Instead, the optical recognition software may be able to inherently to recognize and track the shape of the surgical instrument 94 (or parts of the surgical instrument 94, such as the tip) without any particular fiducial. In addition, if desired, a fiducial (such as a sticker or the like) may be placed on the tissue of the patient. For example, if there is a particular area of interest in the patient, a fiducial could be position on or in the vicinity of the area of interest such that the area of interest remains in the center of view so that it can be tracked during probing, biopsy, etc.

In the embodiment shown in FIGS. 16 and 17, the instrument 94 is movable relative to the reflector 26/scanning unit 12. However, in some cases the instrument 94 may be fixed relative to the scanning unit 12, i.e. when the instrument 94 is coupled to the housing 26 (i.e. shown in FIG. 23). Furthermore, the tracking feature may have the ability to be activated and deactivated. More particularly, during initial entry of the scanning unit 12 into the body the tracking feature may be deactivated, as the scanning unit 12 is moved and manipulated until an area of interest is located. If further operations on or around the area of interest are desired, a fiducial may be positioned on or adjacent to the area of interest, and the tracking feature may be activated. Once the scanning operations are completed the tracking feature can be deactivated so that other areas of interest can be located, if desired.

In order to utilize this tracking feature, a magnetic drive, operated with feedback to provide a constant torque to the reflector 26 about one axis 38, 40, may be utilized. Another magnetic drive, or an electrostatic or other drive, may be provide control about the other axis 38, 40 to “steer” the center of the illuminated area 14 as desired. Thus the tracking feature may require more complex controls than some of the other features and controls described herein.

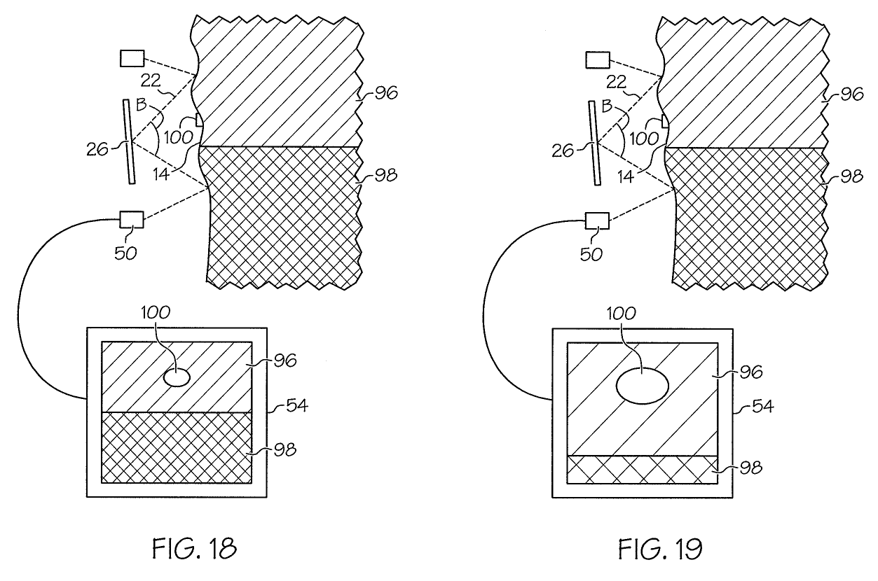

Rather than physically adjusting the reflector, the area 14 may be able to be zoomed and/or panned and/or cropped electronically; that is, by manipulating the data received by the collector 50 in a post data-acquisition, or post radiation-acquisition, manner. For example, as shown in FIG. 18 the area 14 may include two different types of tissue 96, 98, and a lesion 100 may be positioned in the illuminated area 14. The image generated by radiation collected by the collector 50 is displayed on the display device 54. If it is desired to zoom and/or pan and/or crop, such zooming, panning or cropping may be able to be accomplished simply by processing the data of the image shown in FIG. 18. For example, FIG. 19 illustrates an image that is zoomed in compared to the image shown in FIG. 18. As can be seen in comparing FIGS. 18 and 19, the angle B of the reflector 26 may remain the same, as may the positioning of the reflector 26. In this case the image may be zoomed by taking the central pixels of the image of FIG. 18 and spreading them over a larger area.

Electronic/post radiation-acquisition zooming can also be used to exclude the outer edges of the image data (i.e. to crop the image). More particularly, during oscillation of the reflector 26, resolution of the image may be worse at certain areas of the illuminated area. For example, in one case the corners of the illuminated area 14 may have less resolution as compared to the center due to the oblique angle of the beam 22 which can cause reflection away from the collector, and due to distortion. Accordingly, if desired a central “zoom-in,” or crop, feature may be utilized (possibly as an “always-on” or selectively activatable feature) to crop the image and eliminate the corners to provide for an overall better quality image. In this situation, the area defined by the physical limits of the scanning assembly 10 may be desired to be effectively reduced by the user.

Electronic/post radiation-acquisition panning can be accomplished in a similar manner to the electronic zoom as described above. Of course, such electronic/post radiation-acquisition panning and zooming will have a limit due to a loss in resolution. However, because the image data generated by the scanning assembly 10 has high resolution, electronic zoom and panning may be more practical for use with the scanning assembly 10.

Moreover, a scanned beam imaging assembly 10 including the scanning unit 12 may provide superior resolution at smaller sizes compared to a focal plane array device. In a conventional focal plane array imaging device, the spatial character of the image (resolution, position, shapes, distortion, etc.) is governed by the receiving element and its focusing optics. In the scanned beam imaging assembly 10, these attributes are governed by the illuminating element and its optics. In particular, a scanning unit 12 having an effective diameter (i.e. a diameter in end view) of less than about 3 mm may have superior resolution as compared to a focal plane array device of the same effective diameter. These conclusions can also be reached through consideration of basic physical principles. In particular, the wave nature of light and its associated diffraction, plus scattering of the light and charge diffusion in the material of the sensor, sets a lower limit on the practical size of pixels in an FPA. As the overall size of the device is reduced, either the size of the pixels must be reduced, with accompanying loss of performance, or the number of pixels must be reduced, bounding the resolution that can be achieved.

By comparison, in the scanning assembly 10, only a single beam 22 must be focused. In many architectures the beam 22 will contain little energy at angles widely divergent from the central axis. The diffraction issue for the illuminator is not of practical concern. The receiving component of the scanning assembly 10 has no focusing requirement. Light rays reflected from the area 14 may follow any path on their way to the collector 50, and will be correctly associated with the location in the area 14 from which they arose. This permits the collector 50 to be shaped, and placed, as desired.

The character of the area 14 (color, contrast, shading, textures) may be modified by alternate paths taken by the reflected light, but the geometry of the scene remains unchanged through variations in collector size and shape. Thus, even though the scanning unit 12 may be relatively small, a high resolution image which can accommodate significant zooming (i.e. believed to be at least about 2× or, possibly up to 5×), without pixilation visible by the naked eye under normal viewing conditions, may be provided. With appropriate beam focusing, the scanning unit 12 may also be able to increase the pixel count through improvements in detector electronics and thereby increase the spatial resolution of the image prior to post radiation-acquisition panning, zooming or cropping.

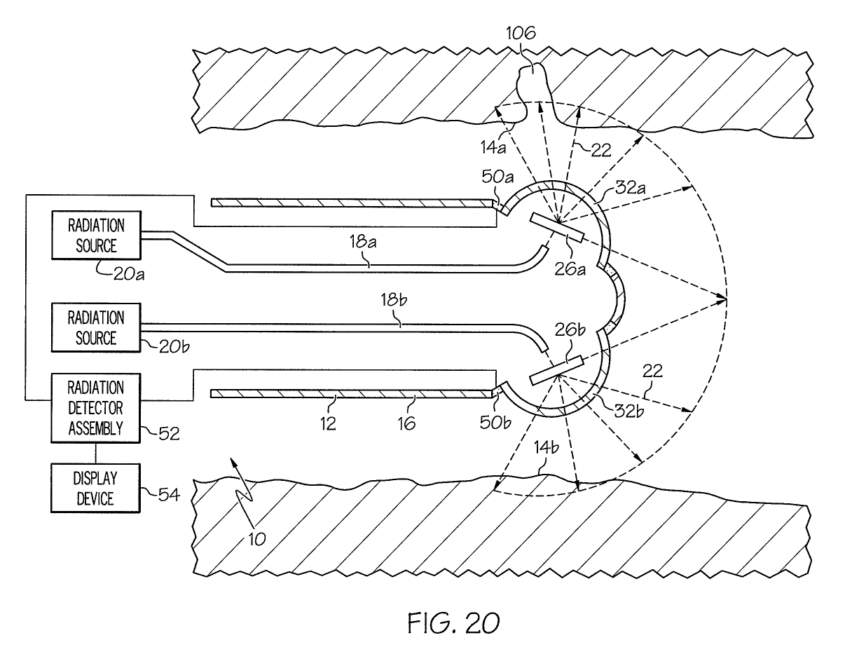

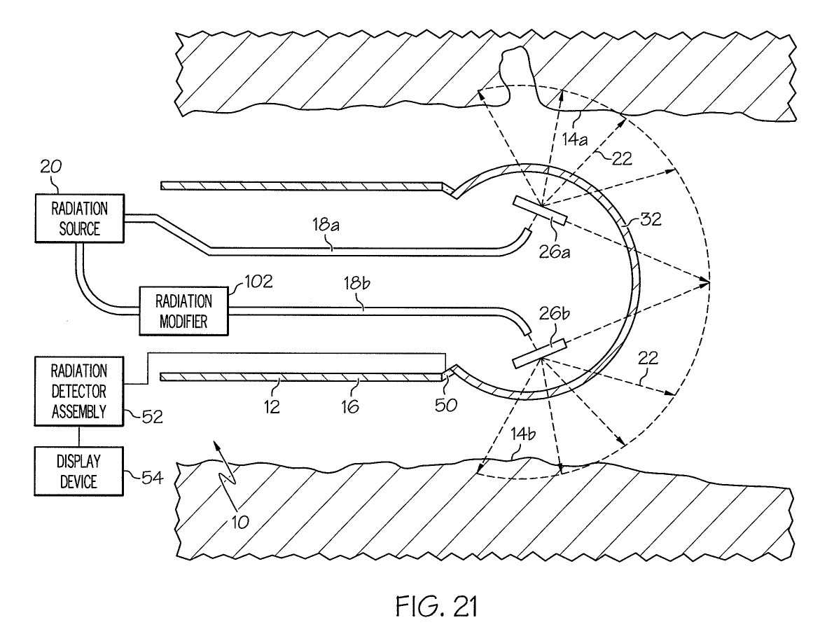

In one embodiment, as shown in FIGS. 20 and 21, the scanning unit 12 may include two reflectors 26a, 26b. Each reflector 26a, 26b may reflect/direction radiation 22 from its own dedicated radiation source 20a, 20b (as shown in FIG. 20). Alternately, the radiation provided to each reflector 26a, 26b may come from a single radiation source 20 (as shown in FIG. 21). When only a single radiation source 20 is utilized, the radiation to at least one reflector 26a, 26b should be modified (i.e. by a “radiation modifier” 102) such that the radiation directed by the reflectors 26a, 26b can be distinguished, as will be described in greater detail below.

The illuminated area 14a defined by reflector 26a may be positioned immediately adjacent to the illuminated area 14b defined by the reflector 26b. If desired the illuminated areas 14a, 14b may overlap to ensure continuous coverage between the two illuminated areas 14a, 14b.

In the illustrated embodiment, each reflector 26a, 26b defines an illuminated area 14a, 14b of about 140° such that the combined illuminated areas are about 280°. The increased illuminated area provides a greater range of view such that an operator can gain a greater understanding of the surrounding environment, and also allows quicker visual inspection of an area with less movement of the scanning unit 12. In addition, the ability of the scanning unit to “see” greater than 180° can be of great value. More particularly, certain endoscopic procedures (such as during a colonoscopy) may place increased emphasis upon visualization during “pull back” or retraction of the endoscopic tool/scanning unit. In these procedures the insertion of the endoscope tool/scanning unit may be utilized primarily to position the endoscopic tool/scanning unit to the desired depth, thereby allowing for analysis and procedures during retraction.

Accordingly in such procedures the ability to present an illuminated area “behind” the endoscopic tool/scanning unit 12 allows the operator the ability to view the “upcoming” scene as the endoscopic tool/scanning unit 12 is retracted without having to retroflex the endoscopic tool/scanning unit 12. In addition, certain features, such as a fissure 106 shown in FIG. 20, may be rearwardly angled relative to the central axis, and such fissures, folds and the like are more easily viewed with the arrangement shown in FIGS. 20 and 21.

As shown in FIG. 20, the rest position, and/or center of oscillation of the reflector 26a, 26b may form an angle, such as between about 100° and about 170° (about 140° in the illustrated embodiment). However, the angle between the reflectors 26a, 26b at their rest positions can be varied as desired.

In the embodiment shown in FIG. 20, each reflector 26a, 26b includes its own associated optical element 32a, 32b and collector 50a, 50b. However, if desired, as shown in FIG. 21, a single optical element 32 may be utilized. A single collector 50 may be utilized to collect radiation from both reflectors 26a, 26b if that collector 50 has an aperture shaped and positioned to collect returned radiation from the necessary angles. In addition, in all cases (i.e. when one, two or more collectors 50 are utilized) the radiation directed by each reflector 26a, 26b may need to be differentiated such that the radiation detector assembly can determine which radiation is associated with which reflector 26a, 26b.

Accordingly, in the embodiment of FIG. 20, each radiation source 20a, 20b may provide radiation that differs from the radiation of the other radiation source 20a, 20b in at least one characteristic that can be detected by the radiation detector assembly 52/controller 46. The at least one differing characteristic may include, but is not limited to, differences in polarization, wavelength (including color), and/or modulation. In the embodiment of FIG. 21, a single radiation source 20 is utilized, and radiation traveling to the reflector 26b is treated or modified (i.e. by passing through a lens or otherwise modified) by the radiation modifier 102 such that the treated/modified radiation differs from the radiation traveling to the reflector 26a.

The image data generated from radiation from each reflector 26a, 26b can be stitched together to form a composite, seamless image of the entire illuminated area of the scanning unit (i.e. 280° in the illustrated embodiment). Alternately, the image generated by radiation from each reflector 26a, 26b may be shown separately in a non-composite image (i.e. two 140° displays).

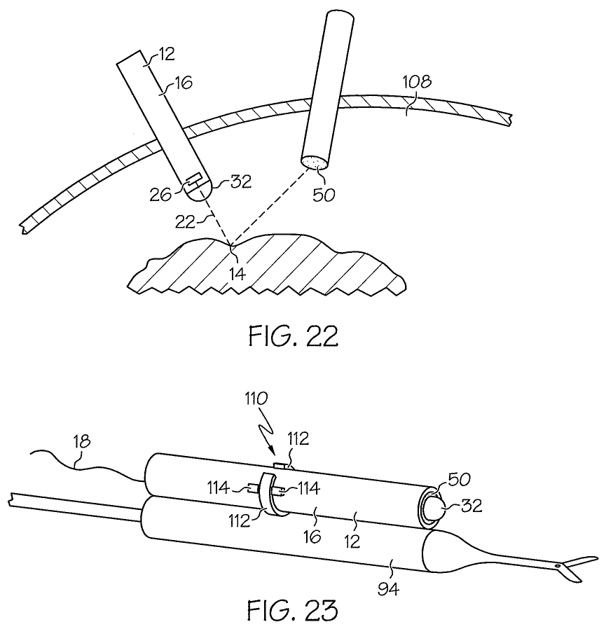

In the embodiments shown in FIGS. 1 and 4, the collector(s) 50 are generally annular and positioned about the associated reflector 26. However, as noted above the collector(s) 50 can take any of a variety of shapes and be located in a variety of positions relative to the associated reflector 26. As shown in FIG. 22, the reflector 26 and collector 50 can be physically remote and not be directly physically or rigidly coupled together. Both the reflector 26 and collector 50 can be introduced into a cavity 108 separately, such as by a needle or trocar. In this case, separation of the reflector 26 and collector 50 allows additional freedom in the movement and positioning of those components. In addition, separating the reflector 26 and collector 50 allows for two relatively small openings to be formed in the body cavity 108, as opposed to a single larger opening, which could be advantageous in certain situations.

As shown in FIG. 23, a scanning unit 12 can be directly physically or rigidly coupled to a surgical instrument 94. Although the instrument 94 in the illustrated embodiment take the form of an endocutter, the instrument can take the form of nearly any instrument used to examine, diagnose and/or treat tissue. The scanning unit 12 allows the operator to view otherwise inaccessible areas in the patient such as behind organs, during trans-gastric exploration or intraluminal inspection, inspection of join capsules, etc. The scanning unit 12 may also be particularly useful in gynecological or colo-rectal surgery, or other applications where visualization may otherwise be difficult.

The scanning unit 12 and instrument 94 may be permanently coupled or removably coupled together. For example, in one embodiment the instrument 94 includes a clip 110 which is configured to receive the scanning unit 12 therein to couple the instrument 94 and scanning unit 12. A pair of detents, in the form of protrusions 114 positioned on the scanning unit 12 and on either side of the clip 110, may be utilized to prevent significant sliding of the scanning unit 12 relative to the instrument 94. However, any of a wide variety of clips, brackets, clasps, ties, inter-engaging geometries, adhesive, magnets, hook and loop fasteners, etc. may be able to be used to releasably couple the scanning unit 12 and instrument 94.

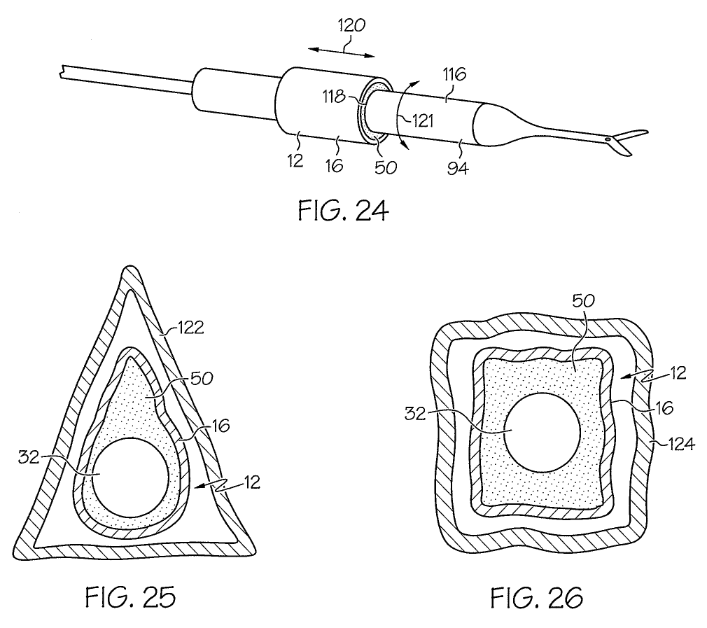

As shown in FIG. 24, the scanning unit 12 may be movably (i.e. slidably in the illustrated embodiment) coupled to the surgical instrument 94. In the illustrated embodiment the surgical instrument 94 includes, or is coupled to, an outer casing 116, and the scanning unit 12 is coupled to, or received about, a carrying sleeve 118 slidably mounted on the outer casing 116. The carrying sleeve 118 may be automatically or manually axially slidable in the direction of arrow 120 to move the scanning unit 12 closer to, or further away from, the distal end of the instrument 94 to allow physical zooming. The scanning unit 12 may also be rotatable about the outer casing 116 (i.e. about arrow 121) to modify the illuminated area as desired. Since the scanning unit of FIG. 20 has a central opening which may be able to receive the carrying sleeve 116 therein, the scanning unit of FIG. 20 may be particularly useful since it can be easily be modified to be hollow. Moreover, instead of the concentric mounting system shown in FIG. 24, the instrument 94 and scanning unit 12 may be slidably or movably mounted in a side-by-side configuration.

As noted above, the scanning unit 12 may be relatively small, yet still provide high resolution. For example, the scanning unit 12 can have a diameter of less than about 5 mm, or alternately less than about 3 mm (providing an end surface area of less than about 19 mm² or less than about 7 mm², respectively). Although relatively high precision may be required for the reflector 26, the reflector 26 can also be made relatively small (i.e. less than about 3 mm²). Thus the small size of the reflector 26 and collector 50 allows the scanning unit 12 to access otherwise inaccessible locations inside the patient's body, and allows the scanning unit 12 to be mounted directly to a surgical instrument for use in the body as shown in, for example, FIGS. 20 and 24.

The reflected radiation can be collected by a collector 50 of various sizes and shapes, including shapes that are non-symmetrical about one or more axes. For example, as shown in FIG. 25, the scanning unit 12 may be desired to pass through a passage 122 that is, as an example, generally triangular in cross section. In this case the collector 50 can be configured in a generally triangular shape to fit through the passage 122 and maximize the usable space. In addition, the collector 50 may be able to be formed into various shapes at later times to pass through other passages, or take other shapes for various other reasons. For example, the scanning unit 12 of FIG. 25 may later be desired to pass through a passage 124 that is generally square in cross section, as shown in FIG. 26. In this case the collector 50 may be able to assume a generally square shape, as shown in FIG. 26 to take maximum advantage of the usable space and/or to access otherwise inaccessible areas.

The collector 50 and/or housing 12 may be able to be automatically formed into various shapes (i.e. by, for example, a conformable casing positioned about the collector fibers). Alternately, the collector 50 may be formed into shape by withdrawing the scanning unit 12/collector 50 from the body, manually or otherwise confirming the collector 50 into the desired shape, and then re-inserting the collector 50. Further alternately, the collector 50 may be permanently configured in one of the shapes shown in FIGS. 25 or 26 (or other shapes). In this case certain collectors 50/scanning units 12, due to their unique shape, may be appropriate for use in certain medical procedures. Finally, the collector 50 may be sufficiently pliable that it can conform into different shapes by outside forces, such as by tissue, as the collector/scanning unit 12 is moved through the patient's body. This can allow the collector 50 to naturally confirm to an appropriate shape to fit through small cavities or the like.

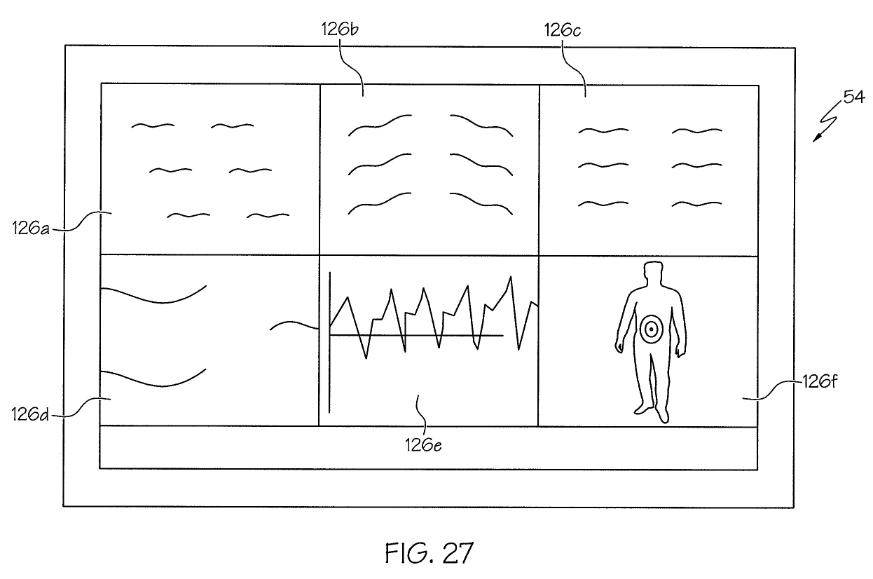

As shown in FIG. 27, the display device 54 may include a screen 126 that is subdivided into various screen segments 126a, 126b, 126c, 126d, 126e, 126f such that various different displays can be simultaneously viewed by the operator. For example, in the embodiment shown in FIGS. 20 and 21 the illuminated areas 14a, 14b may be displayed on different ones of the screen segments 126a-f. As another example, in the embodiment shown in FIGS. 18 and 19, the zoomed and unzoomed areas may be displayed on different ones of the screen segments 126a-f.

Moreover, in certain procedures, such as flexible endoscopy, the operator of a scanning unit 12 may need to be able to visualize the area immediately ahead in order to properly navigate. The operator may also need to be able to visualize the adjacent, lateral areas (i.e. tissue walls) for examination and/or diagnosis. In this case, rather than including two reflectors 26a, 26b (as shown in FIGS. 20 and 21), if desired three reflectors 26 may be utilized to provide a forward looking view, and two side views, and the three different views can be displayed on different ones of the screen segments 126a-f.

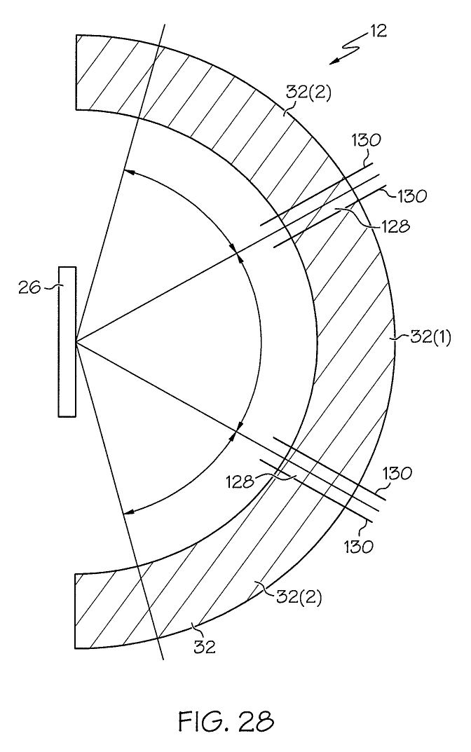

In another embodiment, a multisegment scanning unit 12 (the end of which is shown in FIG. 28) may be utilized with the display device shown in FIG. 27. The scanning unit 12 shown in FIG. 28 includes an optical element 32 that is subdivided into various regions having differing optical power. For example, in one embodiment the central region 32(1) has a substantially zero optical power, and the outer regions 32(2) have a substantially positive optical power. This arrangement provides an “optical zoom” to the beam when it is at certain locations (i.e. passes through the regions 32(2)).

Of course, the optical element 32 and the regions 32(1), 32(2) thereof can be arranged in various manners. For example, the optical element 32 may include more or less than three regions. The regions may each be defined by angles that are generally equal, or the angles may be different. The various regions can each have differing optical powers or magnification (including positive or negative optical power of various values, or optically neutral power) and be arranged in a variety of manners. In addition, besides the angular/concentric arrangement shown in FIG. 28, the optical element 32 may have regions arranged in various other patterns.

The optical element 32 may have transition zones 128 between the various regions 32(1), 32(2) thereof. In the illustrated embodiment the transition zones 128 are defined by line segments 130, which are positioned on either side (i.e. in one embodiment offset by about 50) of the line dividing each region 32(1), 32(2). Due to the varying optical power of the optical element 32 in the transition zones 128, data generated when the beam 22 passes through the transition 128 zones may be discarded or not displayed. Accordingly, the multisegment scanning unit 12 shown in FIG. 28 may be particularly suited for use with the display device shown in FIG. 27, wherein data associated with radiation passing through each region 32(1), 32(2) of the optical element 32 is shown in differing screen segments 126a-f of the display device 54. Thus, in this particular case the screen segments 126a-f may show visualizations taken from different angles, and may also show visualizations at different optical powers.

In one embodiment the display device 50 may take the form of a 16:9 ratio HDTV 1080 display, which has 1920 horizontal pixels and 1080 vertical pixels. Each of the screen segments 126a-f may have a 4:3 (length-to-width) ratio and be displayed in a VGA format, which has 640 horizontal pixels and 480 vertical pixels. Accordingly, it can be seen that a 16:9 ratio HDTV has exactly 3 times as many horizontal pixels as a 4:3 ratio VGA display; and has 2.25 times as many vertical pixels as a 4:3 ratio VGA display. Thus the 16:9 ratio HDTV 1080 display can be subdivided into a 3×2 array to create the screen segments 126a-f shown in FIG. 27. In this case each screen segment 126a-f can have a VGA format, and the screen segments are arranged in a compact manner. Each screen segment 126a-f can show various views or data. For example, one embodiment the top left screen segment 126a displays a side view (i.e. in one case data associated with radiation passing through top region 32(2) of FIG. 28), the top center screen 126b segment displays a center view (i.e. in one case data associated with radiation passing through region 32(1) of FIG. 28), and the top right screen segment 126c displays another side view (i.e. in one case data associated with radiation passing through lower region 32(2) of FIG. 28). However, the display shown in FIG. 27 can be used with various other data acquisition devices besides the scanning unit 12 shown in FIG. 28.

The other screen segments 126d-f may be used to display additional views or data. For example, the screen segments 126d-f may display various still images, vital signs of the patient, zoomed images, a global tracking display, camera and recording system statistics, etc.

While the present invention has been illustrated by a description of several expressions of embodiments, it is not the intention of the applicants to restrict or limit the spirit and scope of the appended claims to such detail. Numerous other variations, changes, and substitutions will occur to those skilled in the art without departing from the scope of the invention. It will be understood that the foregoing description is provided by way of example, and that other modifications may occur to those skilled in the art without departing from the scope and spirit of the appended claims.

What is claimed is:

1. A scanned beam imaging system comprising:
a housing suitable for insertion into a body;
a radiation source configured to direct a beam of radiation into or through said housing and onto an area within the body;
an adjustable element inside said housing and positioned to reflect said beam of radiation or to receive said beam of radiation therethrough, wherein said adjustable element is physically adjustable to vary a property of said beam of radiation that is reflected thereby or received therethrough; and
a collector configured to receive radiation returned from the area within the body.

2. The scanned beam imaging system of claim 1 wherein said adjustable element is a scanning reflector.

3. The scanned beam imaging system of claim 2 wherein said scanning reflector is oscillatable about a first axis and a second axis that is generally perpendicular to said first axis, and wherein during normal operation said reflector is oscillated at or near resonant frequency about said first axis and is oscillated at or near resonant frequency about said second axis.

4. The scanned beam imaging system of claim 2 wherein said system includes an adjusting element coupled to said scanning reflector, said adjusting element having a differing coefficient of thermal expansion than said scanning reflector such that when heat is applied thermal expansion forces cause said scanning reflector to deform.

5. The scanned beam imaging system of claim 1 wherein said adjustable element is a reflecting surface.

6. The scanned beam imaging system of claim 5 further including a scanning reflector, and wherein said reflecting surface is positioned and configured to modify said beam before said beam impinges upon said scanning reflector.

7. The scanned beam imaging system of claim 5 wherein said system includes an adjusting element coupled to said reflecting surface, said adjusting element having a differing coefficient of thermal expansion than said reflecting surface such that when heat is applied thermal expansion forces cause said reflecting surface to deform.

8. The scanned beam imaging system of claim 1 wherein said adjustable element is an adjustable lens.

9. The scanned beam imaging system of claim 8 further including a scanning reflector and wherein said lens and said reflector are configured such that said beam of radiation passes through said lens before being directed by a scanning reflector.

10. The scanned beam imaging system of claim 8 wherein said lens includes an electrically conductive material contained within a encapsulator having a hydrophobic coating on an inner surface thereof.

11. The scanned beam imaging system of claim 10 further including an electrode positioned adjacent to said encapsulator to induce a voltage in at least one of said electrically conductive material or said hydrophobic coating to thereby alter the optical properties of said lens.

12. The scanned beam imaging system of claim 1 further comprising a display device operatively coupled to said collector, said display device being configured to display a representation of radiation received by said collector to thereby display a representation of said area with the body.

13. The scanned beam imaging system of claim 1 further comprising a scanning reflector configured to direct said beam of radiation onto said area with said body, and wherein said system includes a controller operatively coupled to said reflector to control oscillations of said reflector, and wherein said controller is configured to vary an angle of oscillation of said reflector to provide a magnification change.

14. The scanned beam imaging system of claim 13 wherein said controller is configured to dynamically adjust said adjustable element to improve the resolution of an image generated from data provided by said collector, wherein said dynamic adjustment takes into account the varied angle of oscillation of said reflector.

15. The scanned beam imaging system of claim 13 wherein said controller is configured, upon receiving an input from an operator relating to an area of interest, to vary said angle of oscillation of said reflector such that said area receiving directed radiation substantially corresponds to the area of interest.

16. The scanned beam imaging system of claim 1 further comprising a scanning reflector configured to direct said beam of radiation onto said area with said body, and wherein said system includes a controller operatively coupled to said reflector to control oscillations of said reflector, and wherein said controller is configured to vary the positions at which said reflector changes direction during oscillations of said reflector to provide a magnification change.

17. The scanned beam imaging system of claim 1 further comprising a scanning reflector configured to direct said beam of radiation onto said area with said body, and wherein said system includes a controller operatively coupled to said reflector to control oscillations of said reflector, and wherein said controller is configured to cause said reflector to oscillate such that a center of said oscillation is adjusted to provide a panning feature.

18. A method for operating a scanned beam imaging system comprising:
providing a scanned beam imaging system including a housing, a radiation source configured to direct a beam of radiation into or through said housing, a collector, and an adjustable element positioned to reflect said beam of radiation or to receive said beam of radiation therethrough;
inserting said housing into a body such that said beam of radiation is directed onto an area within said body and said collector receives radiation returned from the area within the body; and
physically adjusting said adjustable element to vary a property of said beam of radiation that is reflected thereby or received therethrough.

19. The method of claim 18 wherein said adjusting step includes adjusting said adjustable element to change the angle of divergence of said beam of radiation reflected or received therethrough.

20. The method of claim 18 wherein said scanned beam imaging system includes an oscialltable scanning reflector configured to direct said beam of radiation onto an area within a body, and wherein said adjusting step includes adjusting said adjustable element to vary the optical properties of said beam at least twice during an oscillation of said reflector in a single direction.

21. The method of claim 20 wherein said reflector oscillates in a generally regular manner, and wherein said adjusting step includes periodically adjusting said adjustable element to vary the properties of said beam at a regular interval.

22. A scanned beam imaging system comprising:
an elongated housing suitable for insertion into a body and having an area, in end view of less than about 19 mm²;
a radiation source configured to direct a beam of radiation into or through said housing;
a scanning reflector positioned in said housing and configured to direct said beam of radiation onto an area within the body;
a collector positioned in said housing and configured to receive radiation returned from the area within the body; and
a display device operatively coupled to said collector, said display device being configured to display a representation of radiation received by said collector to thereby display a representation of said area with the body, wherein said display device is configured, upon receiving an input from an operator, to display a zoomed image of part of said representation, wherein said image is electronically zoomed by post radiation-acquisition processing.

23. A scanned beam imaging system comprising:
a housing suitable for insertion into a body;
a radiation source configured to direct a beam of radiation into or through said housing;
an oscillatable scanning reflector configured to direct said beam of radiation onto an area within the body;
a collector configured to receive radiation returned from the area within the body; and
a controller operatively coupled to said reflector to control the oscillations of said reflector, wherein said controller is configured, upon receiving an input from an operator, to vary the amplitude and center of oscillations to provide a zoom and pan feature, and wherein said controller is configured to vary said oscillations such that a predetermined point remains generally at the center of the area scanned by said directed beam of radiation.

24. The scanned beam imaging system of claim 23 wherein said predetermined point is a positioned on, or is part of, a surgical instrument, or is positioned on, or is part of, said body.

25. The scanned beam imaging system of claim 24 wherein said surgical instrument is directly physically coupled to said housing.

26. The scanned beam imaging system of claim 23 wherein said predetermined point is the tip of a surgical instrument, or a fiducial point positioned on a surgical instrument, or a fiducial positioned on said body.

27. The scanned beam imaging system of claim 23 wherein said housing includes a central axis, and wherein said controller is configured to cause said reflector to oscillate such that a center of said oscillation of said reflector is offset from said central axis, if necessary, to ensure that said predetermined point remains generally at the center of the area scanned by said directed beam of radiation.

28. The scanned beam imaging system of claim 23 wherein said reflector resides in a rest position in the absence of any outside forces, and wherein said controller is configured to cause said reflector to oscillate such that a center of said oscillation of said reflector is offset from a line extending generally perpendicular to said rest position, if necessary, to ensure that said predetermined point remains generally at the center of the area scanned by said directed beam of radiation.

29. A scanned beam imaging system comprising:
a housing suitable for insertion into a body;
a radiation source configured to direct a beam of radiation into or through said housing;
at least two scanning oscillatable reflectors configured to direct said beam of radiation onto an area within the body, wherein the combined range of oscillation of said reflectors is greater than 180 degrees; and
a collector configured to receive radiation returned from the area within the body.

30. The scanned beam imaging system of claim 29 wherein the system includes an auxiliary collector configured to receive radiation returned from the area within the body, and wherein the system further includes a display device operatively coupled to said collector and to said auxiliary collector, said display device being configured to display a representation of radiation sensed by said collector and said auxiliary collector to thereby display a representation of said area with the body.

31. The scanned beam imaging system of claim 29 wherein the combined range of oscillation of said reflectors is at least about 280 degrees.

32. The scanned beam imaging system of claim 29 wherein said at least two reflectors include a first reflector and a second reflector, and wherein said first reflector is configured to direct a beam of radiation onto a first sub-area within said body, and said second reflector is configured to direct a beam of radiation onto a second sub-area within said body, and wherein said first and second sub-areas at least partially overlap or are positioned immediately adjacent to each other.

33. The scanned beam imaging system of claim 32 further comprising a display device operatively coupled to said collector, said display device being configured to display a representation of radiation returned from said first and second sub-areas and received by said collector to create a composite representation of said first and second sub-areas.

34. The scanned beam imaging system of claim 32 further comprising a display device operatively coupled to said collector, said display device being configured to display a representation of radiation returned from said first sub-area on a first portion of said display device, and to simultaneously display a representation of radiation received from said second sub-area on a second discrete portion of said display device in a non-composite representation of said first and second sub-areas.

35. The scanned beam imaging system of claim 29 wherein a center of oscillation of each of said reflectors are not parallel and form an angle relative to each other.

36. The scanned beam imaging system of claim 29 wherein the radiation directed by each reflector has at least one differing characteristic relative to each other such that a source of the radiation received by said collector is determinable.

37. The scanned beam imaging system of claim 36 wherein said at least one differing characteristic is polarization, or wavelength, or modulation, or pulsation, or frequency encoding.

38. A scanned beam imaging system comprising:
a housing suitable for insertion into a body;
a radiation source configured to direct a beam of radiation into or through said housing;
a scanning reflector configured to direct said beam of radiation onto an area within the body; and
a collector configured to receive radiation returned from the area within the body, wherein at least one of said collector or said reflector is movable relative to the other.

39. The scanned beam imaging system of claim 38 wherein said collector and said reflector are not rigidly coupled together.

40. The scanned beam imaging system of claim 38 wherein said collector and said reflector are configured to be releasably rigidly coupled together.

41. The scanned beam imaging system of claim 38 further including a surgical instrument, wherein said housing is movably mounted to said surgical instrument.

42. The scanned beam imaging system of claim 41 wherein said housing is slidably mounted to said surgical instrument.

43. The scanned beam imaging system of claim 38 further comprising a surgical instrument, and wherein said collector is movably mounted to said surgical instrument.

44. A scanned beam imaging system comprising:
a housing suitable for insertion into a body;
a radiation source configured to direct a beam of radiation into or through said housing;
a scanning reflector configured to direct said beam of radiation onto an area within the body; and
a collector including an aperture for receiving radiation returned from the area within the body, wherein said aperture is formable into various forms.

45. The scanned beam imaging system of claim 44 wherein said aperture is formable into a non-symmetrical shape.

46. A scanning system comprising:
a scanned beam imaging system including:
a housing suitable for insertion into a body;
a radiation source configured to direct a beam of radiation into or through said housing;
a scanning reflector configured to direct said beam of radiation onto an area within the body; and
a collector configured to receive radiation returned from the area within the body, wherein said scanned beam imaging system is configured to capture image data of at least two differing areas within said area of said body with different magnification with respect to the differing areas; and
a display device operatively coupled to said collector, said display device being divided into six display zones that are simultaneously viewable, wherein at least some of said display zones are configured to display representations of said at least two differing areas.

47. The scanning system of claim 46 wherein at least some of said display zones are configured to display images that are not related to real-time image data captured by said collector.

48. The scanning unit of claim 47 wherein said at least some of said display zones that are configured to display images that are not related to real-time image data captured by said collector are configured to display vital signs of a patient, or at least one still image.

49. The scanning unit of claim 46 wherein said display device is a high definition television screen having a 16:9 aspect ratio, and wherein said display zones are equally sized and arranged in two horizontal rows and three vertical columns.

50. The scanning unit of claim 49 wherein each display zone is of at least VGA quality.

51. The scanning unit of claim 49 wherein one display zone is configured to display real-time images of a first side of image data collected by said collector, a second display zone is configured to display real-time images of a second, opposite side of image data collected by said collector, and a third display zone is configured to display real-time images of a center of image data collected by said collector.
